(19) United States
(12) Patent Application Publication
(10) Pub. No.: US 2009/0070716 A1
(43) Pub. Date: Mar. 12, 2009

(54) SYSTEM AND METHOD FOR OPTIMIZATION AND PREDICATION OF VARIABILITY AND YIELD IN INTEGRATED CIRUITS

(76) Inventors: RAJIV V. JOSHI, Yorktown Heights, NY (US); ROUWAIDA KANJ, Round Rock, TX (US); KEUNWOO KIM, Somers, NY (US)

Correspondence Address: KEUSEY, TUTUNJIAN & BITETTO, P.C., Suite 210, 20 Crossways Park North, Woodbury, NY, 11797, US

(21) Appl. No.: 11/853,930

(22) Filed: Sep. 12, 2007

(51) Int. Cl. G06F 17/50

(52) U.S. Cl. 716/2

(57) ABSTRACT

A system and method for designing a circuit includes generating physics based equations to describe phenomena of a circuit component, representing physical device geometry by correlating the physical device geometry with features of a circuit component design, and integrating the physical based equations and correlated physical device geometry into a computer based model to represent aspects of behavior and geometry for the circuit component. The circuit component is modeled in the presence of variability by statistically analyzing a design space defined by a plurality of parameters in the physics based equations and the physical device geometry to optimize at least one of cost and yield to determine an optimal design point. The circuit component is provided using the optimal design point.

### BACKGROUND

1. Technical Field

The present invention relates to memory circuit design and more particularly to systems and methods for optimizing designs and predicting variability and yield in circuit designs.

2. Description of the Related Art

Variations in process parameters have become increasingly more prevalent in circuit design. In particular, sensitivity to variations is especially troublesome in static random access memory (SRAM) devices since SRAM cells typically are the smallest devices on a chip. In addition, process variations between the neighboring transistors can degrade performance, namely with regard to stability and writeability. As memory chips are made up of millions of cells, a single or a few cell failures can lead to failing memory parts.

Coupled with the process variations, SRAM behavior becomes difficult to predict. There is a lack of accurate physics based models for SRAMs. Many variations can impact SRAM performance. For example, the geometrical impact on channel length (L), channel width (W), oxide thickness (Tₒₓ), silicon thickness (Tₛᵢ), random dopant (Acceptor/Donor) fluctuations, threshold voltage (Vt, threshold voltage is not captured in transistor equations). Therefore, a system and method for the prediction and optimization of SRAM cells is needed.

### SUMMARY

A system and method for designing a circuit includes generating physics based equations to describe phenomena of a circuit component, representing physical device geometry by correlating the physical device geometry with features of a circuit component design, and integrating the physical based equations and correlated physical device geometry into a computer based model to represent aspects of behavior and geometry for the circuit component. The circuit component is modeled in the presence of variability by statistically analyzing a design space defined by a plurality of parameters in the physics based equations and the physical device geometry to optimize at least one of cost and yield to determine an optimal design point. The circuit component is provided using the optimal design point.

A system and method for designing a memory circuit includes obtaining one or more physics based equations to describe one or more phenomena of a circuit component by: generating transistor equations, and representing physical device geometry as a function of features of a circuit component design. A memory cell description is replaced in a computer based model with the one or more physics based equations to represent relationships between aspects of behavior and geometry for the circuit component. The circuit component is modeled in the presence of variability by statistically analyzing a design space defined by a plurality of parameters in the physics based equations and the physical device geometry to optimize at least one of cost and yield to determine an optimal design point. The circuit component is fabricated based on the optimal design point.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a schematic diagram showing an illustrative SRAM cell employed to demonstrate aspects in accordance with the present principles;

FIG. 2 is a block/flow diagram showing a system/method for designing a circuit in accordance with one embodiment;

FIG. 3 is a scanning electron microscope image showing processed features, which are measured for comparison to design components;

FIG. 4 is a block diagram illustratively depicting a statistical analyzer and optimizer for evaluating designs in accordance with the present principles;

FIG. 5 is a diagram showing a design space used to permit variability in parameters and a yield model associated therewith;

FIG. 6A is a linear plot of stability versus yield for a desired design space;

FIG. 6B is a linear plot of writeability versus yield for a desired design space;

FIG. 7 is a table showing results for optimizing a design point in multiple dimensions; and

FIG. 8 is a block/flow diagram showing a system/method for designing a circuit in accordance with the present principles.

### DETAILED DESCRIPTION OF PREFERRED EMBODIMENTS

Present embodiments provide a physics-based or regressive or semi-empirical based statistically-aware predictive system and method for analysis (yield. Performance, writeability, etc.) scaling and optimization of designs in the presence of variability. In one embodiment, a predictive model represents the SRAM cell in the form of physics-based equations that rely on an SRAM-specific physical-based threshold voltage model. Simulations are performed by replacing the SRAM cell with the physics based equations in a netlist. Parameters such as channel length (L), channel width (W), threshold voltage (Vt), etc. of the SRAM cell transistors are represented using geometry dependent relationships established by a physical measurement analysis (e.g., using a scanning electron microscope) in a current technology. Based on the present cell technology information and use of physical models, we can predict future and scaled cell behavior. Other memory systems (e.g., e-DRAM) and other circuits, e.g., logic, etc., are also contemplated in accordance with the present principles.

Experimental results show that the prediction of physics-based model is consistent with results of intensive numerical simulations for scaling an effective channel length (L_{eff}) from 50 nm to 19 nm. By taking into account geometric dependency, the physics based representation of SRAM cell permits accurate prediction and optimization. Thus, static and dynamic variability prediction/optimization can be done using the netlist. This improves run-time significantly. Statistical analysis can be performed using fast statistical methods, e.g., mixture importance sampling, Monte Carlo; it may also rely on factorial analysis, sensitivity analysis, etc. Present embodiments can handle different SRAM performance metrics, and the methods are applicable to multi-dimensional space, i.e., multiple impacting variables. Process paramater matching between designs can be performed as well as model-to-hardware correlations. In addition, the present principles may be employed as a comparator for a variety of SRAM designs/technologies, and predict behavior from one technology to another.

Advantageously, one aspect of the present principles includes that closed-form physics based equations and relationships are input into the simulation tool to provide a complete description of the states (e.g., dependent variables). In this way, a parameter can be computed directly without having to resort to a numerical solution and iterating to convergence. In addition to other aspects, this reduces the computational overhead and the computation time. Many variations can be tested and tested rapidly to provide immediate results.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The designs described herein may be part of the design for an integrated circuit chip. The chip design may be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., Graphic Data System II (GDSII)) for the fabrication of photolithographic masks, which typically include multiple copies of the chip design in question that are to be formed on a wafer. The photolithographic masks are utilized to define areas of the wafer (and/or the layers thereon) to be etched or otherwise processed. The systems and methods described herein may be used in the fabrication of integrated circuit chips.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

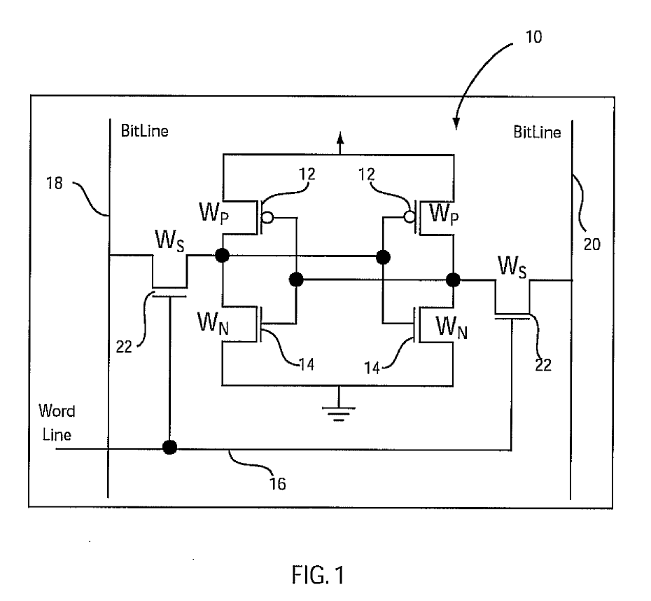

Referring now to the drawings in which like numerals represent the same or similar elements and initially to FIG. 1, an illustrative SRAM cell 10 is shown for demonstrating the present principles. Cell 10 includes cross-coupled p-doped field effect transistors (PFETs) 12 and n-doped field effect transistors (NFETs) 14, which form latches and provide the memory storage function of the cell 10. Access transistors 22 permit access to transistors 12 and 14 in accordance with a signal on a word line 16. Data is written to or read from the cells through access transistors 22 to bitlines 18 and 20.

To further illustrate the present principles the following design parameters are indicated: Wₛ is the channel width of the access transistors 22, Wₚ=β_{P}*Wₛ is the channel width of the PFETs 12, and Wₙ=*Wₛ is the channel width of the NFETS 14. Other design parameters include device or channel length L, threshold voltages (Vt) of the devices, carrier mobility of the devices, gate oxide thickness, silicon thickness (e.g., for silicon-on-insulator (SOI) designs), etc.

Statistical parameters such as a failure probability (P_{fail}) for stability, writeability and performance will be determined based on physics relationships and geometry. Also, regression analysis can be performed to capture the relation between the geometry and its variation in x and y direction. In addition, other parameters may include cost for area, cost for power, etc.

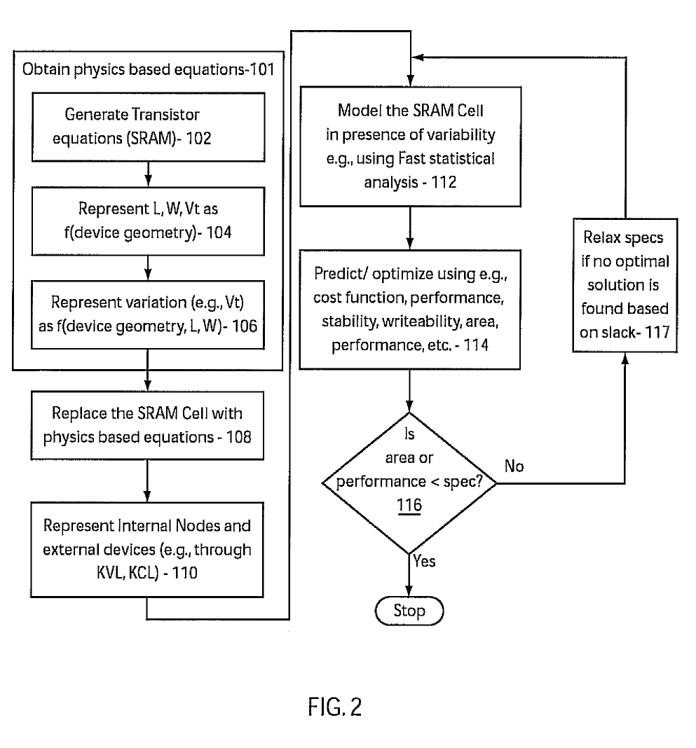

Referring to FIG. 2, a block/flow diagram showing a system/method for prediction of behavior and optimization thereof for a design, e.g., an SRAM cell design. In block 101, an SRAM cell or other circuit is represented in the form of physics based equations, e.g., the physics based equations may be analytical, regressive or semi-empirical equations that preferably have a closed loop solution and can define a discrete solution for one or more parameters of a design. In this way, many or all variations that can impact SRAM performance are accounted for simultaneously. In other words, a change in one parameters impacts other parameters, these variations will be accounted for using the physics based relationships. The physics based relationships may include relationships based on different size scale or circuit hierarchies, for example, an active area region, transistor performance, memory cell performance, memory circuit performance, etc. Impacts to one regime are carried through the analysis to the other regimes thereby providing a comprehensive and accurate analysis takes accounts for the more important impacts on a design. The example of an SRAM cell will now be illustratively described in greater detail.

In block 102, transistor equations are generated for an SRAM cell. E.g., Wₛ is the channel width of the access transistors, Wₚ=β_{P}*Wₛ is the channel width of a PFETs, and Wₙ=βₙ*Wₛ is the channel width of the NFETs. Other design parameters include device or channel length L, threshold voltages (Vt) of the devices, carrier mobility of the devices, gate oxide thickness, etc. These parameters may also be described in greater detail by other physics based equations.

In block 104, L, W, and Vt parameters of SRAM transistors are represented using a geometry dependent relationship established by physical measurements. L, W and Vt may be represented as a function of device geometry. In one embodiment, the physical measurements are performed using scanning electron microscope (SEM) analysis in a current technology. The actual physical dimensions that would be generated by a lithographic mask and/or actually formed on a semiconductor device are studied or modeled to be able to identify the differences between a computer aided or rendered device and an actual device. A regression analysis can also be used to capture the geometric variation in a closed loop form. A regression analysis includes a method for determining the association between a dependent variable and one or more independent variables.

Design systems often render components as well-formed shapes; however, during processing these shapes are not formed in the same way as the virtual elements. For example, rectangles become elliptical or rounded at the corners, other features are blended or rounded. To provide accurate results, the actual physical sizes and dimensions of the features should be known.

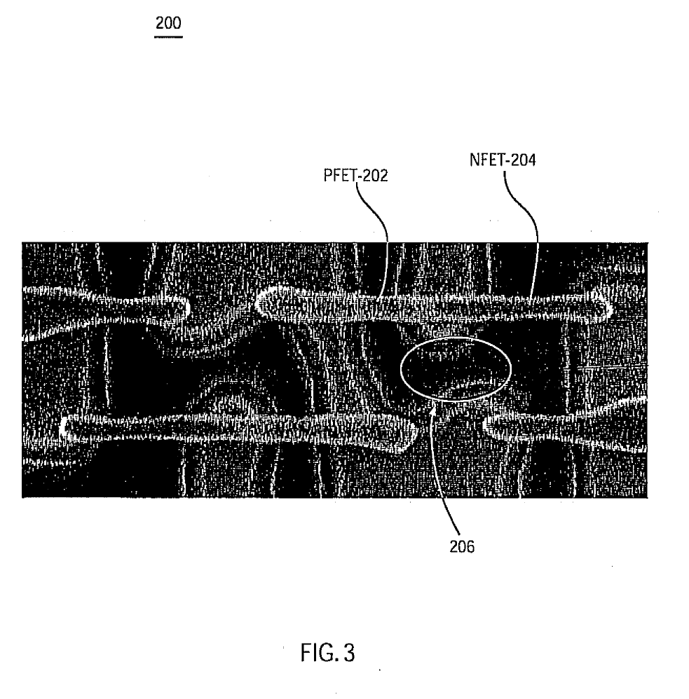

Referring to FIG. 3, a SEM image shows an illustrative silicon-on-insulator SRAM cell 200 having a PFET 202 and an NFET 204. An active area 206 is employed to connect the NFET 204 and PFET 202. Note the rounded dimensions. These dimensions are physically measured (e.g., from the SEM image) and compared to the desired dimensions rendered by a computer aided design program. This results in one or more functions being derived for transforming the theoretical (computer) dimension to actual device geometry. An example of such equations include but are not limited to the following:

W=Wₐ+W_{b}^{m}, L=Lₐ+L_{b}ⁿ, RDF=K/(LW)^{q}, W is the actual transistor width, Wₐ and Wb are component widths to represent linear and non-linear effects to take into account geometric variation. There are many ways that this representation this can be made. L is the actual transistor length, Lₐ and L_{b} are component lengths to represent linear and non-linear effects to take into account geometric variation. RDF is a Random Dopant Function, m, n and q are parameters between 0 and 1, and are employed to define the geometric transformation, and K is a constant.

In block 106, the Vt variation of the transistors of a cell is represented as a function of device geometry, L, W, etc. The geometry can be obtained by physical measurement as in block 104. With reference to FIG. 1, an example of representation of Vt is provided:

$$\begin{matrix}{β}_{P} = {I}_{DS ( s )} / {I}_{DS ( p )} \\ = ( {W}_{s} ( VDD - {V}_{Ts} ) {v}_{s} ( {0}^{+} ) ) / ( WP ( VDD - {V}_{Tp} ) {v}_{P} ( {0}^{+} ) ) \\ = ( {W}_{s} / {W}_{p} ) ( 1 - {V}_{Ts} / VDD ) / ( 1 - {V}_{TP} / VDD ) ( {v}_{s} ( 0 + ) / {v}_{P} ( {0}^{+} ) )\end{matrix}$$

$$\begin{matrix}{β}_{N} = {I}_{DS ( N )} / {I}_{DS ( P )} \\ = ( {W}_{N} ( VDD - {V}_{TN} ) {v}_{N} ( {0}^{+} ) ) / ( {W}_{P} ( VDD - {V}_{Tp} ) {v}_{p} ( {0}^{+} ) ) \\ = ( {W}_{N} / {W}_{P} ) ( 1 - {V}_{TN} / VDD ) / ( 1 - {V}_{TP} / VDD ) ( {v}_{N} ( 0 + ) / {v}_{P} ( {0}^{+} ) )\end{matrix}$$

Based on a biased condition, Vt can be obtained. Also, v (source-injection velocity) can be obtained based on the bias condition (v as a function of Vt). I_{DS} is the source to drain current. V_{T} or Vₜ is the threshold voltage, and VDD is the supply voltage Subscripts N, P and s are parameters related to NFETs 14, PFETs 12 and access transistors 22 as depicted in FIG. 1.

A further example includes physics based equations for the threshold voltage. A Vₜ model for short length (L) FETs is: Vₜ=Vₜ₍ₗᵢₙ₎+ΔV_{t(DIBL)}. (DIBL=Drain Induced Barrier Lowering.)

Vₜ₍ₗᵢₙ₎ is modeled assuming Vₜ₀=the threshold voltage for a long Length (L), then

$${V}_{t 0} = {V}_{FB} + 2 {φ}_{f} - \frac{{Q}_{d}}{{C}_{ox}}$$

where V_{FB}˜−E_{G(St}/q˜−1.1V at T=300K, flat band (FB) condition, E_{G} is energy gap, assuming no fixed oxide charge, no fast-surface state and no Negative Biased Temperature Instability (NBTI) effect,

$$2 {φ}_{f} \approx ( \frac{{kT}_{B}}{q} ) ln ( \frac{{N}_{A ( eff )}}{{n}_{l}} ) \approx 1 V ,$$

where k is the Boltzmann constant, T_{B} is the operating temperature, N_{A(eff)} is the effective number of carriers, nᵢ is intrinsic carrier density, Q_{d}=−qN_{A(eff)}x_{d}˜20 nm where q is a unit charge and x_{d} is the depletion width,
Cₐₓ=εₐₓ/tₐₓ₍ᵢₙᵥ₎; εₐₓ=3.9×8.88×10⁻¹⁴ F/cm; tₐₓ₍ᵢₙᵥ₎˜1.5 nm where Cₐₓ is the oxide capacitance.

Now, ΔV_{t(DIBL)} can be modeled as follows:
Laplace's eq. for V_{DS}—induced incremental change of the potential (Δψ)

$$\frac{{\partial }^{2}}{\partial {x}^{2}} Δ ψ + \frac{{\partial }^{2}}{\partial {y}^{2}} Δ ψ = 0 ⇒ \frac{{\partial }^{2}}{\partial {x}^{2}} Δ ψ = - \frac{{\partial }^{2}}{\partial {y}^{2}} Δ ψ = - η ;$$

$$η ≅ ( 2 / {L}_{eff}^{2} ) {V}_{DS}$$

Integrate it in x

$$Δ {E}_{sb} ( y ) = Δ {E}_{sf} ( y ) + η {t}_{Si} \& Δ {ψ}_{sb} ( y ) - Δ {E}_{sf} ( y ) {t}_{Si} - \frac{η {t}_{Si}^{2}}{2}$$

Gauss's law to front and back surfaces

ΔQ_{ef}=ε_{S1}ΔE_{sf}−C_{of}Δψ_{of} & ΔQ_{cb}−c_{Si}ΔE_{sb}−C_{ob}Δψ_{ob}
Incremental increase of front- and back-surface inv.—charge densities

$$Δ {Q}_{cf} = ( {C}_{of} + {c}_{b} ) {Δψ}_{sf} ( y ) - {C}_{b} {Δψ}_{sb} ( y ) - \frac{{ɛ}_{Si} {t}_{Si} η}{2}$$

$$Δ {Q}_{cb} = - {C}_{b} {Δψ}_{sf} ( y ) - ( {C}_{ob} + {c}_{b} ) {Δψ}_{sb} ( y ) - \frac{{ɛ}_{Si} {t}_{Si} η}{2}$$

where V_{DS} is drain to source voltage, L_{eff} is the effective length, E is the electric field, Q is charge density, C is capacitance, ε is dielectric constant, t is thickness. The subscript Si is for silicon; Sb is back-gate Si surface and Sf is front-gate Si surface. The subscript o is oxide; ob and of are back- and front-gate oxide.

By combining the four above equations, the ΔV_{t(DIBL)} model is obtained as: ΔV_{t(DIBL)}=SS/((60 mV)(Δψ_{sf}^{bulk}) where

$${Δψ}_{sf}^{bulk} = \frac{{ɛ}_{Si} {t}_{d} η}{2 {C}_{ox} ( 1 + α )} ≅ \frac{3 {t}_{d} {t}_{ox} {V}_{DS}}{{L}_{eff}^{2} ( 1 + α )}$$

$$where$$

$${t}_{d} = \sqrt{\frac{4 {ɛ}_{Si} kT ln ( {N}_{A} / {n}_{i} )}{{q}^{2} {N}_{A}}} and$$

α=C_{d}/Cₐₓ˜3tₐₓ/t_{d}. These equations can be employed to define many physical attributes of circuits and components.

Circuit designs are often rendered using computer aided tools. These tools often employ netlists for defining components and nodes.

In accordance with block 108, the physics-based equations, which provide a closed form solution for aspects of interest for a particular design have now been derived. The equations defining the SRAM cell and its features are substituted into a computer design tool which will now employ the physics based equations. If the computer design tool uses netlists, the physics equations are substituted into the program to model the SRAM cell. A netlist is thereby generated replacing the SRAM cell with the physics based equations.

In block 110, internal nodes of each cell or other circuit components may be represented using Kirchoff's Voltage Law (KVL) and/or Kirchoff's Current Law (KCL). In the example, KCL equations can be expressed in terms of the I_{DS} equations above, for block 106. Other governing equations may be employed to determine circuit behavior internally or externally to the SRAM cell. These governing equations may include analytical equations, design specific equation or any other toll for characterizing the circuits.

In block 112, the SRAM cell is modeled in the presence of variability using statistical analysis. Based on the measured and computed parameters, variations are introduced into the computation to develop a range of values. These values can be used to statistically analyze the design using a fast statistical analysis, for example. If a netlist is present, statistical variability analysis and/or optimization may be performed using the netlist. If the netlist is equipped or embedded with equations which are physics or regression analysis or semi-empirical methodology based, then the simulation time for variability analysis or optimization can be significantly reduced. Since the netlist shows a plurality of options a user may select a scenario or parameter that is suitable for the application. Fast statistical sampling may be employed to evaluate P_{fail} for a given design point. Fast statistical sampling overcomes issues such as performance metric approximations which do not provide good representation of tail probabilities (probabilities outside one or two standard deviations). P_{fail} needs to be very small and traditional statistical methods can be inefficient, or very slow in calculations involving small probabilities. Fast statistical sampling to evaluate P_{fail} increases the efficiency of this computation.

Statistical analysis may include any known technique such as Monte Carlo, importance sampling, Uniform Sampling, and may rely on sensitivity analysis, factorial analysis etc. It is possible to build models of P_{fail} (or the equivalent σ-yield) from results of statistical analysis.

Design point as referred to herein is a feature which is being considered for evaluation or testing. The design point may include transistor geometry, cost, performance, etc. The design point can be optimized as will be explained hereinafter. The present embodiments, may provide deterministic results and/or statistical results.

Deterministic optimization results for given design and specs may be determined by e.g., evaluating a minimum Cost: such that f(x)<f₀ where f(x) is the function describing some design property/behavior function (e.g., noise, delay) usually referred to as constraint and f₀ is a desired bound for f(x). For statistical analysis of the design a minimum cost is provided such that P_{fail}<P₀ where P₀ is based on a desired yield and P_{fail}=1—Probability (f(x)<f₀).

In block 114, behavior prediction and optimization of the design or of a chip is performed. This may be performed using one or more of a cost function, performance, stability, writeability, area, power, etc. Area and performance may be employed to measure the optimization level. Based on the present cell technology information and use of physical models, failure predictions may be made, or prediction may be made for scaled cell behavior. For example, since variables are statistically ranged a parameter may be extrapolated to predict the response of a cell or other component when the parameter is changed. This provides flexibility in the design and the design process. The optimization may be grid-based. This means a grid or section of the design is optimized at a time. This helps to reduce the effect of local minima on the entire design (these will be limited to a single section or grid-space). It is also possible to evaluate some grid-points and rely on regression to model other grid points to speed up the optimization/search process.

The methodology is versatile and, advantageously, a plurality of design metrics, specs or constraints can be evaluated simultaneously. For example, using fast statistical methods, SRAM stability, writeability, readability and other performance metrics can be simultaneously evaluated and employed to make prediction or optimization decisions based on multi-dimensional data. Therefore, it is possible to employ constraints that require Yield estimation of memory designs and require specific operating conditions like the cell Vmin (minimum cell supply needed to meet yield constraints) being less than a maximum operating supply voltage VDDmax (Vmin<VDDmax). Optimization and search techniques can be performed in accordance with the present principles.

In block 116, the area or performance measured as a result of the optimization (or behavior prediction scenario) are compared to a specification (spec) to determine if the spec is met. If the spec is met, the system/method ends. Otherwise, the path returns to block 112. This process is iterative and can continue until the spec is met. Otherwise, in block 117 the specification may be relaxed if no optimal solution is found. The relaxing of the specs will be based on any slack or leeway that may be available in the design.

To speed-up simulation, statistical parameters such as σ-Yield (the sigma value on a normal distribution that corresponds to P=1−P_{fail}) may be modeled by response surface modeling of yield as opposed to design point parameters. A linear modeling function is a possible embodiment. The function may be relied upon to predict metrics yield at other design points.

These models can be used in the later optimization stage. This will enhance the runtime significantly. The yield estimate is linearized at different points. Otherwise, statistical analysis at a given design point can be called from within the optimization step for each new candidate design point.

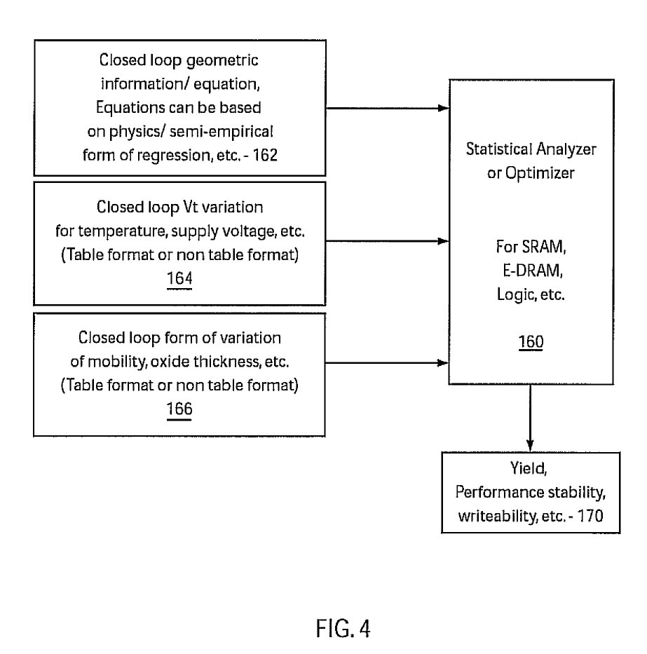

Referring to FIG. 4, a block diagram showing a statistical analyzer and optimizer 160 is illustratively shown. Statistical analyzer 160 includes inputs 162, 164 and 166. In block 162, closed loop geometric information or equations are provided. These equations may include physics, semi-empirical or regression form. The equations may be of different types with the ability to track relationships between variables. In other words, the equations may determine a channel width based on a need threshold voltage and the channel width may in term be employed to size dopant regions, which would then impact a gate area, etc. All of these variables will be interrelated and provide a comprehensive solution.

In block 164, closed loop equations are provided for environmental conditions. These equations may be related to variability of e.g., threshold voltage due to conditions. For example, threshold voltage dependencies due to temperature, supply voltage or other condition changes can be provided. This information may be in equation form or provided in tabular form. For example, a lookup table may be provided with a plurality of conditions and their resulting responses. The equations or table entries provide the ability to track responses due to various conditions. In other words, the equations or tables may determine, e.g., the impact on threshold voltage due to a temperature increase or 10 degrees and a supply voltage drop of 20%. Any number of scenarios can be handled.

In block 166, other closed loop form equations may be employed for geometric/process related variations, e.g., mobility, oxide thickness, dopant density, etc. These parameters may also be in tabular or non-tabular format.

Once all of the information equations are available, the statistical analyzer 160 analyzes a design point based upon a given set or sets of parameters and conditions. The analyzer 160 provides ranges of acceptable responses and/or outputs based on statistical models/distributions. The analyzer 160 further optimizes the solution based upon predetermined criteria or specifications. Analyzer 160 output yields, performance, stability, writeability and any other desired output in block 170.

It should be understood that the present principles are applicable to any integrated circuit technology. Particularly useful embodiments include analysis of SRAM technology, E-DRAM technology, logic circuitry, processors, DRAMs, wireless technology chips, analog designs, etc.

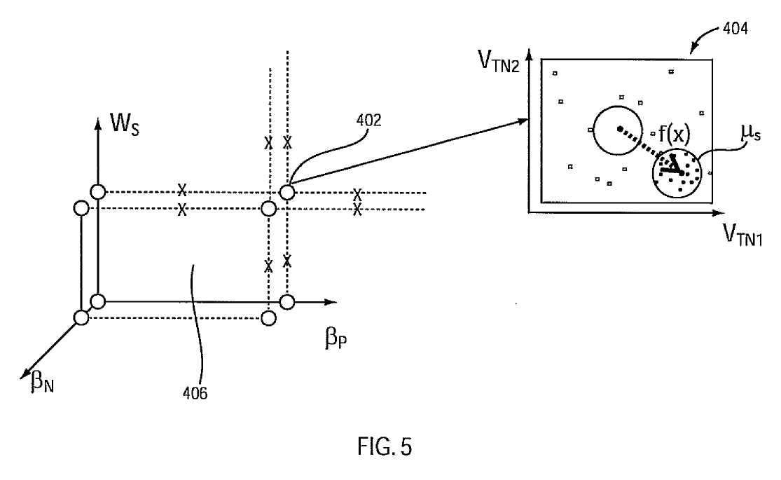

Referring to FIG. 5, a simplified case study is provided to further demonstrate the present principles. Using the physic based equations above, an SRAM cell is to be optimized in the presence of variability. The cell's probability of failure (P_{fail}) need to be evaluated in the design space to find the optimal design points and is required to meet some constraints. Wₛ, β_{N}, and β_{P} are employed to create a design space and are the parameters to be optimized. Design point 402 is an example design point. Alternately, the design space may be divided up into a grid or sections to reduce the problem and eliminate local minima and point 402 can corresponds to a point on that pre-specified grid. The grid can be constructed starting with the minimum Wₛ: W_{S}={0.09, 0.1, 0.11, 0.12, . . . }, then β_{N}, and β_{P} are varied to determine their impact on Wₛ. E.g., β_{N}={0.9, 1.0, 1.1, 1.2} and βₚ={1.8, 1.9, 2.0, 2.1, 2.2}. For a given design point a variability space (e.g., to represent the random threshold voltage variations) 404 is created and a σ-Yield is to be computed using samples from this space. For example, the model 404 includes threshold voltage variations space. This plot can be used to select samples that are employed to estimate yield for a given combination of Wₛ, β_{N}, β_{P}.

A model, preferably a linear model, is constructed for σ-Yield (can be obtained due to threshold voltage mismatch variations or L mismatch variation, etc.) as a function of design space parameters Wₛ, βₙ, and βₚ, e.g., σ-Yield=f(x)=f(Wₛ, β_{N}, β_{P}). This may include experimental data or simulation data collected for that design point and/or the design space occupied by that design point. This yield data may be employed to estimate σ-Yield at other design points. For example, the design points labeled with ‘o’ (like 402) can be used to build the model. The model in turn can be used to predict yield at design points labeled with ‘x’ in FIG. 5 (e.g., a projected value).

The design point may be constrained by setting realistic or design constraints on the acceptable range of the design point. For example, the total area which is f(Wₛ, β_{N}, β_{P}), or a function of the design point, may be limited to 125% of a predefined area based on a scaled design or other requirements. To optimize the design point in this illustrative example, the design point should satisfy the yield requirement and provide the minimum costs in one or more of area, power, delay, etc. To satisfy the yield requirement, the design point should exceed a predetermined value for yield. To satisfy the cost the design point should provide the minimum cost. A similar analysis can be performed on any variable or set of variables, e.g., L, Vt, dopant densities, etc. Sampling in the parameter space via mixture importance sampling functions enables low/rare failure probability estimation independent of assumptions regarding performance metrics, dimensional limitations, or failure region.

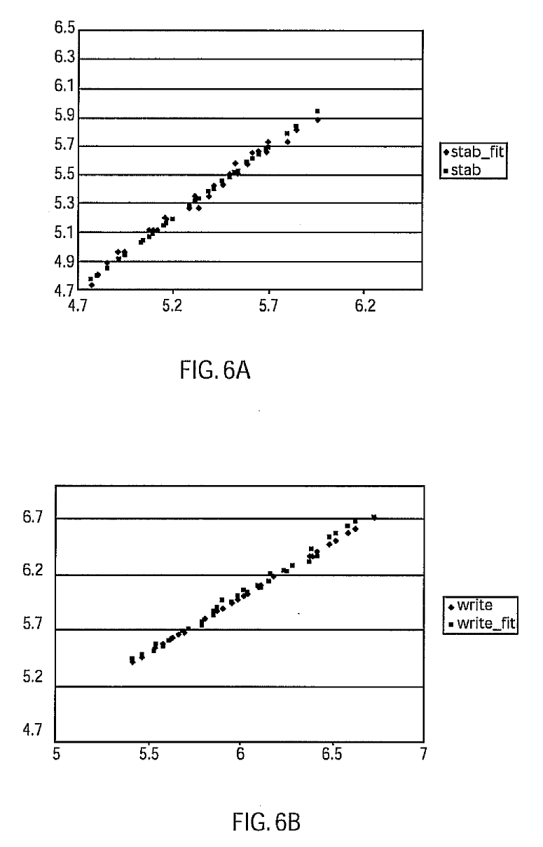

Referring to FIGS. 6A and 6B, estimated σ-Yield is shown for points in the desired design space. FIG. 6A shows the linear model's accuracy at predicting σ-Yield versus σ-Yield obtained using a full blown statistical analysis simulation. This is shown for different designs points in the desired design space. FIG. 6A shows stability yield actual data versus best fit data. σ-Yield is provided in a linear relationship to permit ease of computation. FIG. 6B shows writeability yield for actual data versus best fit data.

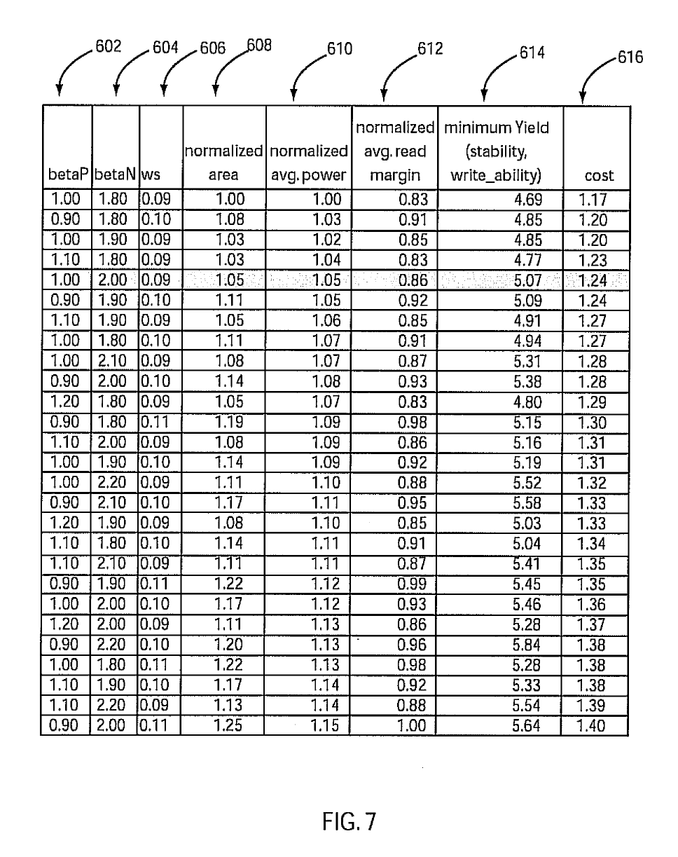

Referring to FIG. 7, results of the optimization process are shown in tabular form arranged in order according to cost shown in column 616. Different values for β_{P} (betaP) in column 602, β_{N} (betaN) in column 604, Wₛ (ws) in column 606 define the design space. Normalized area, normalized power and normalized average read margin corresponding to each set of values are depicted in columns 608, 610 and 612, respectively. Minimum yield for stability and writeability corresponding to each set of values are depicted in column 614.

Accordingly to FIG. 7, each design point may be balanced against others and a determination that optimizes the design based on multiple dimensions can be made. For example, a lowest cost and highest yield may be traded off against other parameters such as average power, etc.

In accordance with the present principles, the predictions using the physics-based model are consistent with results obtained by intensive numerical simulations for scaling L_{eff} from 50 nm to 19 nm. The present embodiments may be employed by circuit designers to optimize SRAM cells or any other circuit component, and provide designs which take into consideration area, power, delay, stability and writeability in the presence of process variations. By relying on fast statistical methods, e.g., mixture importance sampling, the present efficient method finds the approximate center of gravity of a failure region, and estimates low/rare failure probabilities of SRAM designs. The present principles are applicable to multi-dimensional space and employ multiple impacting variables to arrive at a solution. The physics based representation of SRAM cell takes into account geometric dependency and permits accurate prediction and optimization.

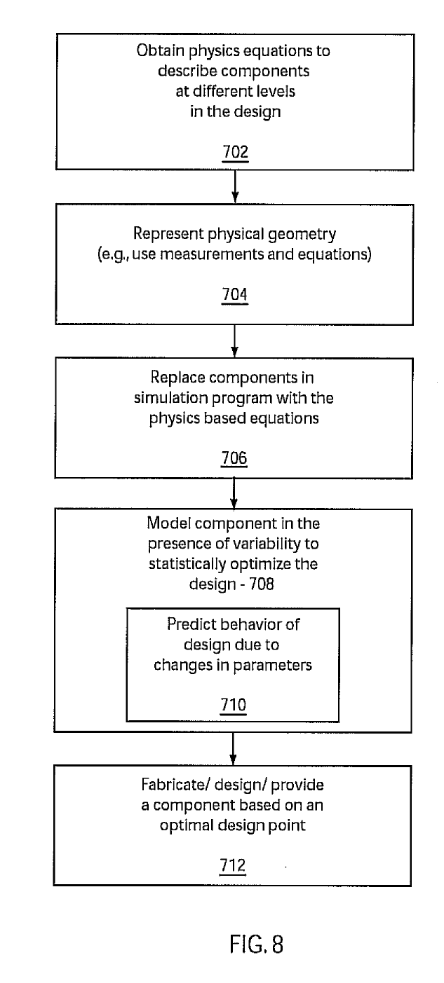

Referring to FIG. 8, a system/method for designing a circuit, preferably a memory circuit is illustratively shown. In block 702, one or more physics based equations are obtained or derived to describe one or more phenomena of a component. This includes generating transistors equations, memory cell equations, threshold voltage variations. The equations can be related to one another such that, given a set of parameters, a design parameter(s) can be evaluated. A closed form solution is preferably provided for characteristics and behavior of the component to be designed where all relevant aspects of the components behavior are defines by the equations. The physics based equations can define different phenomena and be related to each other to define the aspects of behavior at different levels of the design.

In block 704, physical device geometry is represented as a function of features of a component design. The actual fabricated geometry is determined or measured and correlated to the design geometry (e.g., the computer defined parameters). The representation may rely on measurements from a physical circuit, device or lithographic pattern or mask to compute feature sizes and relate the feature sizes to the component design. The measuring the physical circuit may employ, a microscope, e.g., a SEM.

In block 706, a memory cell or other component description is replaced in a computer based model with the one or more physics based equations to represent relationships between aspects of behavior and geometry for the circuit component. The computer based model may include known simulation programs/tools; however the physics based equation will provide complete flexibility since any impact due to a change any variables or parameters will have a determinable solution.

In block 708, the circuit component is modeled in the presence of variability by statistically analyzing a design space defined by a plurality of parameters in the physics based equations and the physical device geometry to optimize at least one of cost and yield to determine an optimal design point. In block 710, the modeling of the circuit component includes predicting a behavior of another component based upon a statistical analysis of the design space. This may include predicting how components behave if projected into a different technology, or how components behave in a same technology where at least one of a plurality of parameters is different. The model can be employed to compare two designs for performance, area, yield, etc. In block 712, the circuit component can be designed, fabricated or otherwise provided in accordance with the optimal design point.

Having described preferred embodiments of a system and method for optimization and prediction of variability and yield in integrated circuits (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for designing a circuit, comprising the steps of:
generating one or more physics based equations to describe one or more phenomena of a circuit component;
representing physical device geometry by correlating the physical device geometry with features of a circuit component design;
integrating the physics based equations and correlated physical device geometry into a computer based model to represent aspects of behavior and geometry for the circuit component;
modeling the circuit component in the presence of variability by statistically analyzing a design space defined by a plurality of parameters in the physics based equations and the physical device geometry to optimize at least one of cost and yield to determine an optimal design point; and
providing the circuit component using the optimal design point.

2. The method as recited in claim 1, wherein generating one or more physics based equations includes providing a closed form solution for characteristics and behavior of the component.

3. The method as recited in claim 1, wherein generating one or more physics based equations includes relating physics based equations defining different phenomena to each other to define the aspects of behavior at different levels of the design.

4. The method as recited in claim 1, wherein representing physical device geometry includes measuring a physical circuit to compute feature sizes and relating the feature sizes to the circuit component design.

5. The method as recited in claim 1, wherein measuring the physical circuit includes employing a microscope.

6. The method as recited in claim 1, wherein modeling the circuit component includes predicting a behavior of another circuit component based upon a statistical analysis of the design space.

7. The method as recited in claim 6, wherein the another circuit component is one of a component in a different technology and a component in a same technology where at least one of the plurality of parameters is different.

8. The method as recited in claim 1, wherein modeling the circuit component includes computing a yield for the design space to determine the optimal design point.

9. The method as recited in claim 1, wherein the step of generating includes providing equations based upon one of regression analysis and semi-empirical forms.

10. A computer readable storage medium comprising a computer readable program for designing a circuit, wherein the computer readable program when executed on a computer causes the computer to perform the steps of:
generating one or more physics based equations to describe one or more phenomena of a circuit component;
representing physical device geometry by correlating the physical device geometry with features of a circuit component design;
integrating the physics based equations and correlated physical device geometry into a computer based model to represent aspects of behavior and geometry for the circuit component;
modeling the circuit component in the presence of variability by statistically analyzing a design space defined by a plurality of parameters in the physics based equations and the physical device geometry to optimize at least one of cost and yield to determine an optimal design point; and
providing the circuit component using the optimal design point.

11. A method for designing a memory circuit, comprising the steps of:
obtaining one or more physics based equations to describe one or more phenomena of a circuit component by:
generating transistor equations; and
representing physical device geometry as a function of features of a circuit component design;
replacing a memory cell description in a computer based model with the one or more physics based equations to represent relationships between aspects of behavior and geometry for the circuit component;
modeling the circuit component in the presence of variability by statistically analyzing a design space defined by a plurality of parameters in the physics based equations and the physical device geometry to optimize at least one of cost and yield to determine an optimal design point; and
fabricating the circuit component based on the optimal design point.

12. The method as recited in claim 11, wherein generating one or more physics based equations includes providing a closed form solution for characteristics and behavior of the circuit component.

13. The method as recited in claim 11, wherein generating one or more physics based equations includes relating physics based equations defining different phenomena to each other to define the aspects of behavior at different levels of the design.

14. The method as recited in claim 1 wherein representing physical device geometry includes measuring a physical circuit to compute feature sizes and relating the feature sizes to the circuit component design.

15. The method as recited in claim 14, wherein measuring the physical circuit includes employing a microscope.

16. The method as recited in claim 11, wherein modeling the circuit component includes predicting a behavior of another circuit component based upon a statistical analysis of the design space.

17. The method as recited in claim 16, wherein the another circuit component is one of a component in a different technology and a component in a same technology where at least one of the plurality of parameters is different.

18. The method as recited in claim 11, wherein modeling the circuit component includes computing a yield for the design space to determine the optimal design point.

19. The method as recited in claim 11, wherein the step of generating includes providing equations based upon one of regression analysis and semi-empirical forms.

20. A computer readable storage medium comprising a computer readable program for designing a memory circuit, wherein the computer readable program when executed on a computer causes the computer to perform the steps of:
obtaining one or more physics based equations to describe one or more phenomena of a component by:
generating transistors equations;
representing physical device geometry as a function of features of a component design; and
replacing a memory cell description in a computer based model with the one or more physics based equations to represent relationships between aspects of behavior and geometry for the circuit component;
modeling the circuit component in the presence of variability by statistically analyzing a design space defined by a plurality of parameters in the physics based equations and the physical device geometry to optimize at least one of cost and yield to determine an optimal design point; and
providing the circuit component based on the optimal design point.
